(19) United States
(12) Patent Application Publication
(10) Pub. No.: US 2014/0172758 A1
(43) Pub. Date: Jun. 19, 2014

(54) PERSONAL EMERGENCY RESPONSE SYSTEM BY NONINTRUSIVE LOAD MONITORING

(71) Applicant: Robert Bosch GmbH, Stuttgart (DE)

(72) Inventors: Roland Klinnert, Korntal (DE); Naveen Ramakrishnan, Wexford, PA (US); Michael Dambier, Bretten (DE); Felix Maus, Pittsburgh, PA (US); Diego Benitez, Pittsburgh, PA (US)

(73) Assignee: Robert Bosch GmbH, Stuttgart (DE)

(21) Appl. No.: 14/133,715

(22) Filed: Dec. 19, 2013

Related U.S. Application Data
(60) Provisional application No. 61/739,643, filed on Dec. 19, 2012.

(51) Int. Cl. G06N 99/00

(52) U.S. Cl. CPC G06N 99/005
USPC 706/12

(57) ABSTRACT

A method for a personal emergency response system includes receiving output signals of a nonintrusive load monitoring (NILM)system coupled to an electrical supply of an person's residence, the output signals indicating switching events of appliances connected to the electrical supply. A computer processor is then used to process the output signals in accordance with a machine learning algorithm to identify appliance activation routines. Rules are defined based on the identified appliance activation routines, and the computer processor is used to monitor the output signals and apply the rules to the output signals to identify appliance switching conditions that violate the rules.

### CROSS-REFERENCE TO RELATED APPLICATIONS

This application claims priority to U.S. Provisional Application Ser. No. 61/739,643 entitled “ PERSONAL EMERGENCY RESPONSE SYSTEM BY NONINTRUSIVE LOAD MONITORING” by Klinnert et al., filed Dec. 19, 2012, the disclosure of which is hereby incorporated herein by reference in its entirety.

### TECHNICAL FIELD

The present disclosure relates generally to electronic monitoring systems, and in particular, to electronic monitoring for personal emergency response systems (PERS).

### BACKGROUND

In general, Personal Emergency Response Systems (PERS) are systems utilized by the elderly and infirm individuals living alone to assist the individual in alerting appropriate personnel in emergency situations. PERS often include some kind of portable device that is worn by the individual that is equipped with a transmitter and a push button. The transmitter is configured to alert a monitoring facility in response to the button being pushed. The portable device enables a monitoring facility or emergency response center to be alerted when the individual cannot reach a telephone.

To augment the PERS, some systems include sensors, such as motion sensors, installed in every room of the individuals residence for detecting movement (and inactivity) in the residence. A recent innovation has also been implemented in which a learning module is incorporated into the system that is configured to learn typical movement patterns based on the output of the motion sensors and to use the typical movement patterns as a model to detect anomalies, such as prolonged inactivity, indicative of personal emergencies.

While the pushbutton transmitter and sensors provide an effective PERS, the pushbutton transmitter must be carried at all times and the individual must be capable pushing the button to activate it. In addition, the sensors require careful installation and periodic inspections to ensure that they are working properly.

### DRAWINGS

FIG. 1 schematically depicts an embodiment of a PERS by non-intrusive load monitoring in accordance with the present disclosure.

FIG. 2 schematically depicts an embodiment of the NILM processing unit and NILM output processing system of FIG. 1.

### DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one of ordinary skill in the art to which this disclosure pertains.

The present disclosure is directed to a personal emergency response system (PERS) that does not require installation of sensors in all rooms nor any sensing device to be carried by the individual being monitored. The PERS disclosed herein is configured to make use of a Nonintrusive Load Monitoring (NILM) system, as is known in the art, which detects and classifies the switching events of various electrical appliances using only a single point of measurement, usually the electrical mains of a building.

According to the present disclosure, the NILM system output is processed by a learning module. The learning module implements a machine learning algorithm which processes the switching events from the NILM system to learn typical activity patterns of the resident on certain days and at various times of the day and generates a learned model to classify this activity. The learned model can then be used to detect any abnormalities in the daily switching events, such as inactivity, that may be indicative of emergency situations.

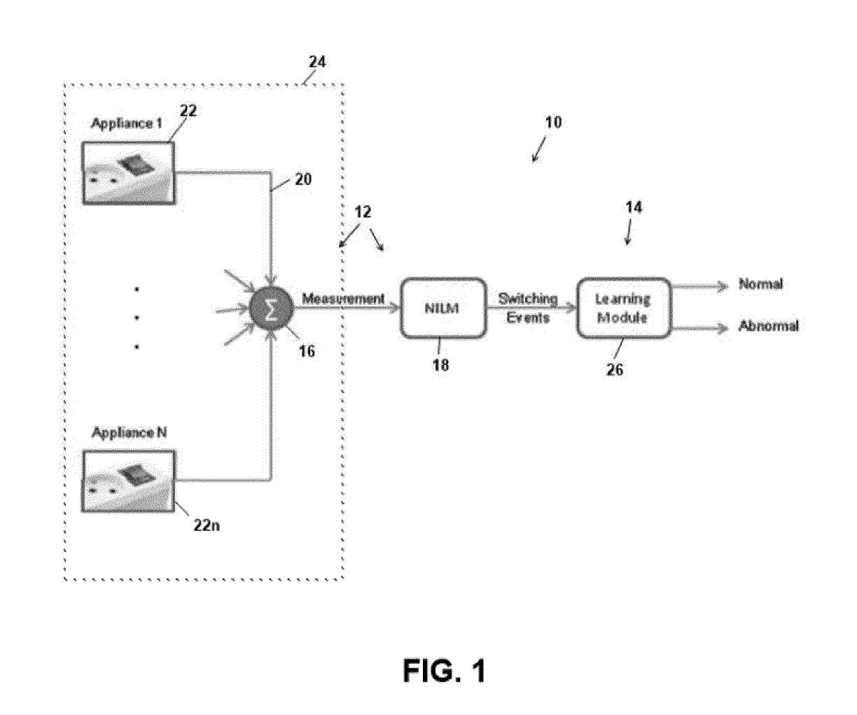

FIG. 1 schematically depicts an embodiment of a PERS 10 with non-intrusive load monitoring in accordance with the present disclosure. As depicted in FIG. 1, the system includes a NILM system 12 and a NILM output processing system 14. The NILM system 12 includes a measuring unit 16 and a processing unit 18. The measuring unit 16 is coupled to an electrical circuit 20 that is connected to a number of appliances 22 in a residence 24. In one embodiment, the measuring unit 16 comprises an electric meter that is connected to the electrical mains of the residence 24.

The appliances 22 are switched on and off independently by the individual living at the residence based on their daily activity. The measuring unit 16 provides a measurement of the total load on the circuit 20 to the processing unit 18. The processing unit 18 is configured to monitor the total load to detect signature variations in the current and/or voltage waveforms that are indicative of an appliance being switched on or off, i.e., switching events. For example, if the residence contains a refrigerator which consumes 250 W and 200 VAR, then step increases and decreases of that characteristic size provide an indication of the on and off switching events for the refrigerator. By analyzing the current and voltage waveforms of the total load, the processing unit estimates the number and nature of the individual loads, their individual energy consumption, and other relevant statistics such as time-of-day variations. No access to the individual components is necessary for installing sensors or making measurements. For a more detailed description of nonintrusive load monitoring systems, please refer to U.S. patent application Ser. No. 13/331,822, entitled “Method for Unsupervised Non-Intrusive Load Monitoring” to Ramakrishnan et al., the disclosure of which is incorporated herein by reference in its entirety.

The processing unit 18 outputs switching event data to the NILM output processing system 14. The switching event data includes information that identifies the times of day that each appliance is turned on and off. The switching events are received by a learning module 26 of the NILM output processing system 14. The learning module 26 is configured to process the switch event data to generate a learned model that represents the normal or typical on/off switching times of each appliance. The learning module is configured to use the learned model to detect abnormal switching event activity, such as prolonged periods of inactivity or prolonged periods in which a certain appliance is turned on. When abnormal activity is detected, the NILM output processing unit 14 is configured to transmit an alert to a monitoring facility or emergency response center.

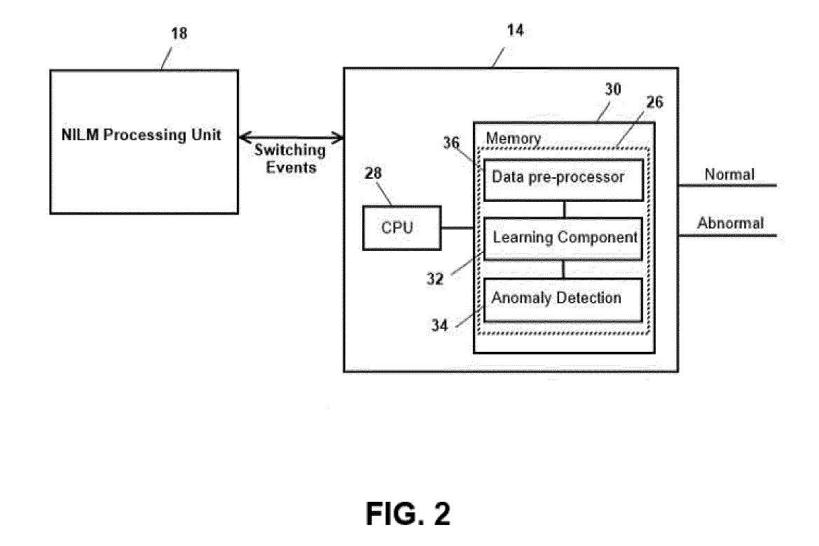

FIG. 2 depicts a schematic view of an embodiment of the NILM output processing system 14. As depicted in FIG. 2, the processing system 14 includes a processor 28, such as a central processing unit (CPU), an application specific integrated circuit (ASIC), a field programmable gate array (FPGA) device, or a micro-controller. The processor 28 is configured to execute programmed instructions that are stored in the memory 30. The memory 30 can be any suitable type of memory, including solid state memory, magnetic memory, or optical memory, just to name a few, and can be implemented in a single device or distributed across multiple devices.

The programmed instructions stored in memory include instructions for implementing the learning module 26. The learning module includes a learning component 32 and an anomaly detection component 34. The learning component 32 implements a machine learning algorithm to process the switch event data received from the NILM processing unit 18 to identify switching event times that are “typical” or “normal”. Examples of algorithms that may be implemented in the learning module 24 include Cluster Analysis, Artificial Neural Networks, Support Vector Machines, k-Nearest Neighbors, Gaussian Mixture Models, Naive Bayes, Decision Tree, RBF classifiers and the like. A data pre-processor 36 may be implemented in the processing system for preparing and filtering the switching data for the learning component to eliminate data that could produce misleading results.

The switching events are either logged or processed in real-time by the learning module which learns the behavior of the resident over a period of time. Examples of behavior or activities which can be learned include, for example, regular cooking (e.g., by oven, microwave switching), regular room visits (e.g., by light switching), bathroom trips (e.g., by light, fan, hair dryer switching). The durations that certain appliances are turned on or off can be monitored to detect abnormal periods of inactivity or inappropriate activity (e.g., electric oven being left on) which can indicate emergency situations.

After learning a model of the resident's behavior, the switching event data are used to classify the resident's behavior as normal or abnormal. For example, the learning component 32 may include instructions for defining rules or parameters (e.g., learned rules) that defines normal switching behavior, such as on/off switching times and durations. The anomaly detection component 34 applies the learned rules to the switch event data to identify abnormal switching behavior. The anomaly detection component may also include predetermined rules for define certain switching behavior as normal or abnormal without having to be learned beforehand, e.g., prolonged periods of certain appliances being turned on/off. When the anomaly detection component 34 detects abnormal switching behavior, the processing system 14 can transmit an alert to a monitoring facility or emergency response center.

In one embodiment, the NILM output processing system 14 is incorporated into the NILM system 12 so that the detecting, learning, and anomaly detection are all implemented in the same system. In this embodiment, the device may be configured to transmit alerts via a communication system to the remote monitoring facility or emergency response center when abnormal switching events are detected. Any suitable type of communication system may be used, including computer networks, wireless or wired, radio, and standard cellular telephone technology. As an alternative, the NILM system 12 can be configured to transfer switching event data to a remote facility for processing. For example, switching event log files can be transferred to a remote monitoring facility where learning and anomaly detection can take place. This obviates the need for a separate hardware/software to be installed at the residence.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for a personal emergency response system, the method comprising:
receiving output signals of a nonintrusive load monitoring (NILM)system coupled to an electrical supply of an person's residence, the output signals indicating switching events of appliances connected to the electrical supply;
using a computer processor to process the output signals in accordance with a machine learning algorithm to identify appliance activation routines;
defining rules based on the identified appliance activation routines; and
using the computer processor to monitor the output signals and apply the rules to the output signals to identify appliance switching conditions that violate the rules.

2. The method of claim 1, further comprising:
generating an alert when an appliance switching condition that violates the rules is identified.

3. The method of claim 2, wherein generating the alert includes automatically transmitting an alert signal to a monitoring system.

4. The method of claim 3, wherein the rules define times of day for switching events during which the switching events will be deemed to be in violation or not in violation of the rules.

5. The method of claim 3, wherein the rules define a period of time for continuous inactivity of an appliance that will be deemed a violation of the rules.

6. The method of claim 3, wherein the rules define a period of time for continuous activation of an appliance that will be deemed a violation of the rules.

7. The method of claim 1, wherein the computer processor is incorporated into the NILM system.

8. The method of claim 1, wherein the NILM system includes an electric meter.

9. An emergency response system comprising:
a nonintrusive load monitoring (NILM) system coupled to an electrical supply of an person's residence and configured to generated output signals indicating switching events of appliances connected to the electrical supply; and
a NILM output processing system coupled to receive the output signals from the NILM system and to process the output signals using a machine learning algorithm to identify appliance activation routines and to apply rules based on the identified appliance activation routines to the switching events indicated by the output signals to identify appliance switching conditions that violate the rules.

10. The system of claim 9, wherein the NILM output processing system includes a processor and a memory, the memory including programmed instructions for execution by the processor to implement the machine learning algorithm.

11. The system of claim 10, wherein the NILM system includes an electric meter, and
wherein the NILM output processing system is incorporated into the electric meter.

12. The system of claim 11, further comprising:
a communication system for transmitting an alert to a monitoring facility or emergency response center.

13. The system of claim 9, wherein the rules define times of day for switching events during which the switching events will be deemed to be in violation or not in violation of the rules.

14. The system of claim 9, wherein the rules define a period of time for continuous inactivity of an appliance that will be deemed a violation of the rules.

15. The system of claim 9, wherein the rules define a period of time for continuous activation of an appliance that will be deemed a violation of the rules.
